(19) United States
(12) Patent Application Publication
(10) Pub. No.: US 2013/0216658 A1
(43) Pub. Date: Aug. 22, 2013

(54) TEXTURED, FREEZE-DRIED PRODUCTS AND METHODS FOR MAKING SAME

(71) Applicants: Raphael Schaller, Newaygo, MI (US); Barbara Burzinski Hartliep, Spring Lake, MI (US)

(72) Inventors: Raphael Schaller, Newaygo, MI (US); Barbara Burzinski Hartliep, Spring Lake, MI (US)

(73) Assignee: Nestec S.A., Vevey (CH)

(21) Appl. No.: 13/811,137

(22) PCT Filed: Jul. 18, 2011
(86) PCT No.: PCT/US11/44405

§ 371 Date: Feb. 27, 2013

Related U.S. Application Data
(60) Provisional application No. 61/365,481, filed on Jul. 19, 2010.

(51) Int. Cl. A23P 1/12

(52) U.S. Cl. CPC A23P 1/125
USPC 426/92; 426/89; 426/102; 426/93; 426/385

(57) ABSTRACT

Textured, co-deposited, freeze-dried food products are provided, as well as methods of making same. In a general embodiment, the food products have a first component and a second component that are disposed adjacent one another. The first and second components may be the same or different materials and may have any number of distinguishable characteristics including, but not limited to, flavor, color, texture, optical properties, etc. The food products are subjected to a sublimation step during manufacturing to remove excess water in the food product to provide a freeze-dried food product.

### BACKGROUND

The present disclosure relates generally to food technologies. More specifically, the present disclosure relates to textured, dual component freeze-dried products and methods of making same.

Dual component food products are known in the food industry and are typically produced using known coextrusion or codepositing apparatuses. As such, many dual component food products on the market share similar characteristics and properties, and suffer from a limited number of characteristics to distinguishing the two components of the dual food product. Accordingly, consumers may become bored and unexcited about the aesthetics of typical dual component food products. In turn, companies who manufacture such dual component food products may suffer from increased expenditures for marketing purposes in response to an overall decrease in the purchasing of such products. In addition, companies may seek more cost- and labor-efficient methods for manufacturing more appealing food products.

### SUMMARY

Textured, freeze-dried food products are provided. Methods of making the food products are also provided. In a general embodiment, the present disclosure provides food products having an outer component that surrounds an inner component to form a food product. The entire product is freeze-dried and the outer component and the inner component are visibly distinguishable.

In an embodiment, the outer component completely surrounds the inner component such that the inner component is not visible on an outer surface of the food product. The outer component serves as a shell, while the inner component is a filling component within the shell.

In an embodiment, the outer component is selected from the group consisting of a yogurt or other dairy product, a puree, a cereal product, a cheese, a fruit, a vegetable, a meat, a malt, a chocolate, coffee, fish or other seafood, or combinations thereof. The inner component may be selected from the group consisting of a yogurt or other dairy product, a puree, a cereal product, a cheese, a fruit, a vegetable, a meat, a malt, a chocolate, coffee, fish or other seafood, or combinations thereof.

In an embodiment, the color, texture, and flavor of the outer component may be different from the color, texture, and flavor of the inner component, respectively.

In an embodiment, the food product is dissolvable. The food product may have a water content below about 2%, and the food product may have a volume between about 500 and about 3000 mm³.

In another embodiment, a food product is provided and includes a first component and a second component that form a food product. The entire food product is freeze-dried and the first component and the second component are visibly distinguishable.

In an embodiment, the first and second components are both visible on an outer surface of the food product. The first and second components may form, for example, a marbleized design on the outer surface of the food product, or a swirl design on the outer surface of the food product.

In an embodiment, the first component is selected from the group consisting of a yogurt or other dairy product, a puree, a cereal product, a cheese, a fruit, a vegetable, a meat, a malt, a chocolate, coffee, fish or other seafood, or combinations thereof. The second component may be selected from the group consisting of a yogurt or other dairy product, a puree, a cereal product, a cheese, a fruit, a vegetable, a meat, a malt, a chocolate, coffee, fish or other seafood, or combinations thereof.

In an embodiment, the color, texture, and flavor of the first component may be different from the color, texture, and flavor of the second component, respectively.

In an embodiment, the food product is dissolvable. The food product may have a water content below about 2%, and the food product may have a volume between about 500 and about 3000 mm³.

In yet another embodiment, methods for making a food product is provided. The methods include codepositing a first component and second component at a temperature below about 10° C. to form a product, cooling the product to a temperature below about −5° C., and subjecting the product to a sublimation step for a predetermined amount of time and at a predetermined pressure.

In an embodiment, the first component is selected from the group consisting of a yogurt or other dairy product, a puree, a cereal product, a cheese, a fruit, a vegetable, a meat, a malt, a chocolate, coffee, fish or other seafood, or combinations thereof. The second component may be selected from the group consisting of a yogurt or other dairy product, a puree, a cereal product, a cheese, a fruit, a vegetable, a meat, a malt, a chocolate, coffee, fish or other seafood, or combinations thereof.

In an embodiment, the codepositing occurs at a temperature from about −5° C. to about 10° C.

In an embodiment, the first and second components are viscous components having a viscosity between about 5 and about 600 Pas.

In an embodiment, the predetermined amount of time for the sublimation step is about 5 to about 20 hours. The predetermined pressure may be from about 0.1 to about 1.0 mbar.

In an embodiment, the sublimation step includes heating the product at a temperature between about 50° C. and 120° C. The final temperature of the product after sublimation may be between about 20° C. and 80° C.

In an embodiment, the methods further include codepositing the first and second components onto a flat surface.

In an embodiment, the methods further include aerating the first component and/or the second component prior to the codepositing step.

In still yet another embodiment, methods of making a food product are provided. The methods include preparing a first viscous component, preparing a second viscous component, aerating the first component and/or the second component, codepositing the first component and second component to form a product, freezing the product, and subjecting the product to a sublimation step for a predetermined amount of time and at a predetermined pressure.

In an embodiment, the first component is selected from the group consisting of a yogurt or other dairy product, a puree, a cereal product, a cheese, a fruit, a vegetable, a meat, a malt, a chocolate, coffee, fish or other seafood, or combinations thereof. The second component may be selected from the group consisting of a yogurt or other dairy product, a puree, a cereal product, a cheese, a fruit, a vegetable, a meat, a malt, a chocolate, coffee, fish or other seafood, or combinations thereof.

In an embodiment, the codepositing occurs at a temperature from about −5° C. to about 10° C.

In an embodiment, the first and second viscous components have a viscosity between about 5 and about 600 Pas.

In an embodiment, the predetermined amount of time is about 5 to about 20 hours. The predetermined pressure may be about 0.1 to about 1.0 mbar.

In an embodiment, the sublimation step includes heating the product at a temperature between about 50° C. and 120° C. The final temperature of the product after sublimation may be between about 20° C. and 80° C.

In an embodiment, the methods further include codepositing first and second components onto a flat surface.

An advantage of the present disclosure is to provide an improved dual component food product.

Another advantage of the present disclosure is to provide a texturized, freeze-dried food product.

Yet another advantage of the present disclosure is to provide a texturally appealing food product.

Another advantage of the present disclosure is to provide a visibly appealing food product.

Still yet another advantage of the present disclosure is to provide improved methods of making a dual component food product.

Additional features and advantages are described herein, and will be apparent from, the following Detailed Description and the figures.

### BRIEF DESCRIPTION OF THE FIGURES

FIG. 1 is a front view of a dual component food product in accordance with an embodiment of the present disclosure.

FIG. 2 is a cross-sectional view of a dual component food product of FIG. 1 in accordance with an embodiment of the present disclose and taken along line II-II of FIG. 1.

FIG. 3 is a front view of a dual component food product in accordance with an embodiment of the present disclosure.

FIG. 4 is a cross-sectional view of a dual component food product of FIG. 3 in accordance with an embodiment of the present disclose and taken along line IV-IV of FIG. 3.

FIG. 5 is a front view of a dual component food product in accordance with an embodiment of the present disclosure.

FIG. 6 is a cross-sectional view of a dual component food product of FIG. 5 in accordance with an embodiment of the present disclose and taken along line VI-VI of FIG. 5.

### DETAILED DESCRIPTION

The present disclosure is generally directed to food technology. More specifically, the present disclosure is directed to co-deposited, freeze-dried food products, as well as methods of making same. Freeze-drying is a dehydration process typically used to preserve a perishable material or make the material more convenient for transport. Freeze-drying works by freezing the material and then reducing the surrounding pressure and adding enough heat to allow the frozen water in the material to sublime directly from the solid phase to the gas phase. In a general embodiment, the food products have a first component and a second component that are disposed adjacent one another. The first and second components may be the same or different materials and may have any number of distinguishable characteristics including, but not limited to, flavor, color, texture, amount, optical properties, etc.

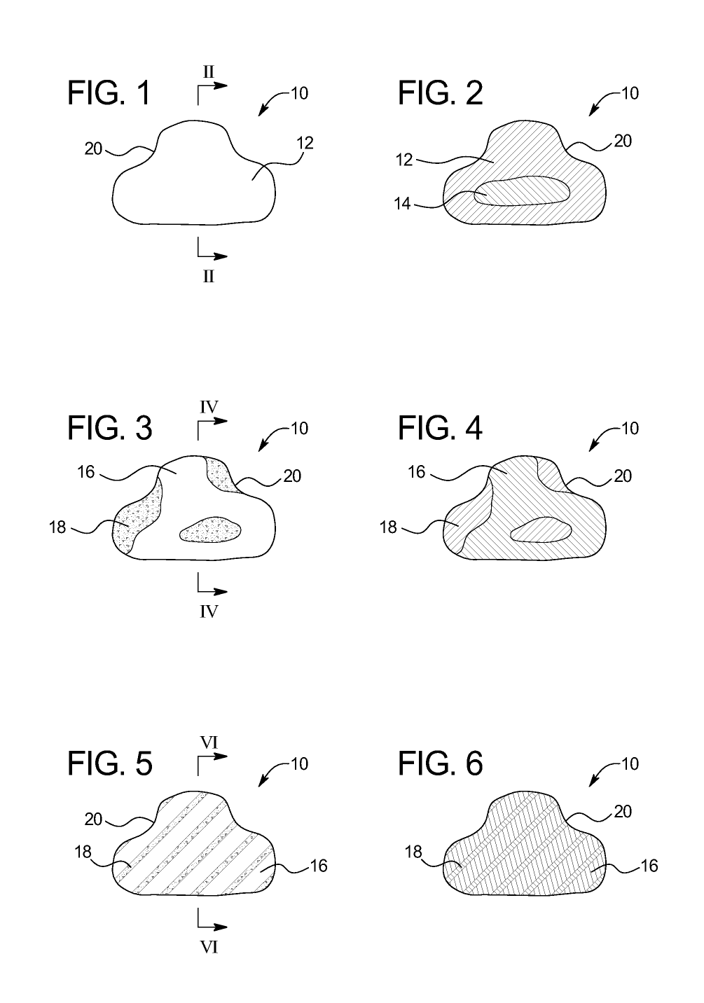

As shown in FIG. 1, an embodiment of a dual component food product of the present disclosure is generally designated by the numeral 10. The dual component food product 10 includes an outer component 12 and an inner component 14, as is shown by the cross-sectional view in FIG. 2. Although the food product 10 is shown in FIG. 1 as including inner component 14, the skilled artisan will appreciate that the food product 10 need not necessarily contain inner component 14. In such an embodiment, the food product 10 will still be a texturized, freeze-dried food product. As shown in FIG. 1, the food product 10 assumes a substantially hemispherical configuration having a tip portion 20 at the top of food product 10. However, while food product 10 is shown in a substantially hemispherical configuration, the skilled artisan will appreciate that other geometric shapes are possible. For example, food product 10 may be substantially oval, circular, square, triangular or other various geometric shapes. In an embodiment, food product 10 may have a substantially oblong shape (not shown). In other words, food product 10 may have an elongated shape with substantially curved sides. In yet another embodiment, food product 10 may have an elongated cylindrical shape so as to form an elongated food product in the shape of a stick (not shown).

As will be discussed herein below, however, an advantage provided by the present food product 10 and methods of making same is that food product 10 need not have a predefined shape imparted by the use of a mold, as is required by typical food products. Instead, the present food products 10 may be formed simply by co-depositing the outer component 12 with the inner component 14 onto a flat surface. The use of such a manufacturing process provides reduced costs in preparation of the products, as well as reduced labor, faster manufacturing times, and reduction in potential manufacturing complications. In an alternative embodiment, however, the skilled artisan will appreciate that a mold may be used, although is not required, if a different or specific shape of food product 10 is desired.

The outer and inner components 12, 14 of food product 10 may have unique properties or characteristics associated therewith. For example, as shown in the FIGS. 1 and 2, food product 10 may include an outer component 12 that substantially surrounds an inner component 14. In this embodiment, inner component 14 is not visible to a consumer until food product 10 is broken open to reveal an inner portion of food product 10. Indeed, in this embodiment, all that is seen by the consumer prior to breaking open food product 10 is outer component 12.

In another embodiment, however, food product 10 may include a marbleized appearance that is visible to the consumer prior to breaking open food product 10, as is shown by FIGS. 3 and 4. In this embodiment, a first component 16 and a second component 18 are both visible to a consumer, as is shown by FIG. 3. Similarly, when food product 10 is broken open, the cross-sectional view in FIG. 4 illustrates that first and second components 16, 18 are still visible to the consumer. FIGS. 5 and 6 illustrate yet another embodiment similar to the marbleized embodiment, wherein first component 16 and second component 18 are both visible to the consumer on the outside of food product 10 (FIG. 5) and on the inside of food product 10 (FIG. 6). However, first component 16 and second component 18 form a swirl design in FIG. 5, as opposed to the marbleized design of FIG. 3. Accordingly, the skilled artisan will appreciate that other combinations of first and second components 16, 18 are possible and that the present disclosure is not limited to the embodiments disclosed herein.

The dual component food products 10 of the present disclosure may have different outer components 12 and inner components 14. Similarly, the dual component food products 10 of the present disclosure may have different first and second components 16, 18. Going forward, for convenience, “first component” will be used to refer to both the outer component 12 and first component 16, while “second component” will be used to refer to both the inner component 14 and second component 18.

In an embodiment, the material of first component 12, 16 and second component 14, 18, may be different. For example, first component 12, 16 may be a yogurt or other dairy product, a puree, a cereal product, a cheese, a fruit, a vegetable, a meat, a malt, chocolate, coffee, fish or other seafood, or combinations thereof. Similarly, first component 12, 16 may also be a food composition that is flavored. First component 12, 16 may include, a flavoring selected from the group consisting of, for example, butter, nut, vanilla, fruit, herb, spice, or combinations thereof. Similarly, first component 12, 16 may also include, for example, inclusions selected from the group consisting of fruit pieces, herbs, spices, vegetables, cheeses, confectionery materials, or combinations thereof.

In an embodiment wherein second component 14, 18 is different from first component 12, 16, second component 14, 18 may be a yogurt or other dairy product, a puree, a cereal product, a cheese, a fruit, a vegetable, a meat, a malt, chocolate, coffee, fish or other seafood, or combinations thereof. Similarly, second component 14, 18 may also be a food composition that is flavored. Second component 14, 18 may include, but is not limited to, flavorings selected from the group consisting of butter, nut, vanilla, fruit, herb, spice, or combinations thereof. Similarly, second component 14, 18 may also include, for example, inclusions selected from the group consisting of fruit pieces, herbs, spices, vegetables, cheeses, confectionery materials, or combinations thereof.

Typical meat components may include, but are not limited to, poultry, beef, pork, fish, or combinations thereof. Cheese components may include, but are not limited to, american, swiss, cheddar, blue, colby, brie, or combinations thereof. Fruit components may include any known fruit such as, but not limited to, apples, bananas, coconut, pear, apricot, peach, nectarines, plum, cherry, blackberry, raspberry, mulberry, strawberry, cranberry, blueberry, grapes, grapefruit, kiwi, rhubarb, papaya, melon, watermelon, pomegranate, lemon, lime, mandarin, orange, tangerine, guava, mango, pineapple, etc. Vegetable components include any known vegetable such as, but not limited to, amaranth, arugula, brussels sprouts, cabbage, celery lettuce, radicchio, water cress, spinach mushrooms, peas, beans, beets, carrots, potatoes, radish, rutabaga, turnips, etc. Various other components may include, for example, cereals, malts, chocolate, coffee, cacao, and other various dairy products such as, but not limited to, yogurt or kefir.

In an embodiment, first component 12, 16 is yogurt, second component 14, 18 is a strawberry puree, and both first component 12, 16 and second component 14, 18 are aerated prior to codeposition. By providing two different components in the present food products 10, the skilled artisan will appreciate that the food products 10 may also provide a wide variety of taste sensations including, for example, sweet, savory, bitter, sour, salty, or combinations thereof.

To further distinguish first component 12, 16 from second component 14, 18, different colorings may be used. The food colorings may be a natural food coloring, or may be an artificial food coloring. For example, in an embodiment wherein a naturally white colored yogurt is used as a first component and a naturally red colored strawberry puree is used as a second component, food product 10 will have a red component contained entirely within, marbleized with, or swirled with a white component, depending on the desired aesthetics of the final product. Alternatively, if the same naturally white yogurt first component is dyed green using an artificial green food coloring, food product 10 will have a red component contained entirely within, marbleized with, or swirled with a green component. Accordingly, the skilled artisan will appreciate that any known coloring scheme may be used with food products 10 to distinguish first component 12, 16 from second component 14, 18.

In addition to the use of different colors for the components of food product 10, the use of different material properties may also be used for the components of food product 10. In this manner, first component 12, 16 may be made of a material having different optical properties than second component 14, 18. For example, either or both of first component 12, 16 and second component 14, 18 may be made of transparent, translucent or opaque materials. In the field of optics, transparency is the physical property of allowing light to pass through a material, while translucency only allows light to pass through diffusely. Opacity is the opposite property of transparency. Transparent materials are clear, while translucent ones cannot be seen through clearly, and opaque materials cannot be seen through at all.

Food product 10 according to the present disclosure may also provide distinct appearances by varying the amount of first component 12, 16 with respect to second component 14, 18. For example, the ratio of first component 12, 16 to second component 14, 18 may be 1:1. In another embodiment, the ratio may be 1:2, and vice versa. In yet another embodiment, the ratio may be 1:3, 1:4, 1:5, etc. Accordingly, the skilled artisan will appreciate that the ratio of first component 12, 16 to second component 14, 18 will vary depending on the desired appearance of food product 10.

Further, food product 10 according to the present disclosure may provide distinct textures and dissolvable properties by aerating or not aerating specific components of food product 10 prior to coextrusion or codeposition. Going forward, and for convenience, “codeposition” will be used with respect to the present process by which food products 10 are prepared. However, the skilled artisan will appreciate that other processes such as, for example, coextrusion may be used. In an embodiment, first component 12, 16 is aerated and is combined with second component 14, 18, which is not aerated, during codeposition. In another embodiment, first component 12, 16 is not aerated and is combined with second component 14, 16, which is aerated, during codeposition. Alternatively, both first component 12, 16 and second component 14, 18 may be aerated, or both first component 12, 16 and second component 14, 18 are not aerated. Accordingly, food product 10 may be provided with several different textural properties and may also be dissolvable.

The present disclosure also provides methods of making food product 10. As discussed above, first component 12, 16 and second component 14, 18 are prepared separately prior to codeposition. Codeposition is carried out using any apparatus known in the art and capable of codepositing two separate streams of a product. For example, codeposition may be carried out using a coextruder apparatus that simultaneously extrudes a first outer casing around a second core component. Instead of extruding a tubular food product from a die of a coextruder, however, the food product having two components is deposited in individual portions onto a surface.

As is discussed above, either or both of first component 12, 16 and second component 14, 18 may be aerated. Additionally, first component 12, 16 and second component 14, 18 are not liquid, but are in a viscous state prior to and at the time of codeposition. For example, first component 12, 16 and second component 14, 18 may have a viscosity from about 5 Pas and 600 Pas at the time of codeposition.

Further, at the time of codeposition, when a stream of viscous first component 12, 16 and a stream of viscous second component 14, 18 contact, there exists no significant difference in temperature between the two components. For example, in an embodiment, the two streams have a temperature that is less than about 10° C. In another embodiment, the two streams are contacted at a temperature from about −5° C. to about 10° C.

When the two streams of first component 12, 16 and second component 14, 18 meet during codeposition, the combined streams may be codeposited on a flat surface to form a product without the use of a mold. Alternatively, however, the skilled artisan will appreciate that a mold may be used if a specific shape were desired for a final product. Once the combined streams are codeposited to form a product, the product has a density of about 0.25 to about 1.5 g/ml. In an embodiment, the product has a density of about 0.5 to about 1.2 g/ml. The shape of the product on the flat surface may further be stabilized by cooling the temperature of the product to less than about −5° C. In an embodiment, the product has a hardness that is between about 30 and about 120 N when the temperature is between about −5° C. and about −25° C.

To remove water from typical codeposited products, evaporation and heating are typically used. However, Applicants have surprisingly found that a textured, co-deposited, freeze-dried product having unique characteristics may be formed by removing water using a sublimation step. Sublimation is the transition of a substance from the solid phase to the gas phase without passing through an intermediate liquid phase. Sublimation is an endothermic phase transition that occurs at temperatures and pressures below a substance's triple point in its phase diagram.

The sublimation step of the present disclosure usually takes from about 2 to about 25 hours to complete using a vacuum. In an embodiment, the sublimation step is carried out for about 5 hours to about 20 hours. In another embodiment, the vacuum applied during sublimation is between 0.1 and 1.0 mbar. During sublimation, the product is heated at a temperature from about 50 to about 120° C. At the end of the sublimation step, the temperature of the final product is about 20 to about 80° C.

Applicants have surprisingly found that a freeze-dried product may be obtained by using sublimation, wherein the final product has a water content below about 2%. In an embodiment, the final product has a water content of about 1%. Applicants have also found that such a manufacturing method also provides a product with a volume between about 500 and about 3,000 mm³. In an embodiment, the volume of the final product is between about 1,000 and about 2,500 mm³. In yet another embodiment, the volume of the final product is about 1,500 mm³.

The use of the manufacturing procedures described herein above provide food products of the present disclosure with unique and novel characteristics. Further, the manufacturing procedures described herein provide a more cost-effective and efficient manner in which to manufacture the food products. Indeed, cost-saving and efficiency promoting steps of the present methods include, for example, co-depositing of the first and second components in viscous conditions and at the same temperature comprised below 10° C. and in one shot, and shaping of the food product without the use of a mold, as is typically required with similar food products. Accordingly, by using the unique and novel manufacturing steps described herein, Applicants are able to provide an aesthetically appealing and unique texturized, co-deposited, freeze-dried product.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A dissolvable food product comprising:
a first component and a second component that form a food product, wherein the entire food product is freeze-dried and the first component and the second component are visibly distinguishable;
wherein the first component may be selected from the group consisting of a yogurt or other dairy product, a puree, a cereal product, a cheese, a fruit, a vegetable, a meat, a malt, a chocolate, coffee, fish or other seafood, and combinations thereof; and
wherein the second component is selected from the group consisting of a yogurt or other dairy product, a puree, a cereal product, a cheese, a fruit, a vegetable, a meat, a malt, a chocolate, coffee, fish or other seafood, and combinations thereof.

2. The food product of claim 1, wherein:
the color of the second component is different from the color of the first component;
the texture of the second component is different from the texture of the first component; or
the flavor of the second component is different from the flavor of the first component; or combinations thereof.

3. The food product of claim 1, wherein at least one of the first component and the second component is a dairy product.

4. The food product of claim 1, wherein at least one of the first component and the second component is a yogurt.

5. The food product of claim 1, wherein at least one of the first component and the second component is a fruit puree.

6. The food product of claim 1, wherein at least one of the first component and the second component is vegetable puree.

7. The food product of claim 1, wherein the food product has a water content below about 2%.

8. The food product of claim 1, wherein the food product has a volume between about 500 and about 3000 mm³.

9. The food product of claim 1, wherein the first component surrounds the second component.

10. The food product of claim 9, wherein the first component completely surrounds the second component such that the second component is not visible on an outer surface of the food product.

11. The food product of claim 1, wherein the first and second components form a marbleized design on the outer surface of the food product.

12. The food product of claim 1, wherein the first and second components form a swirl design on the outer surface of the food product.

13. A method of making a dissolvable food product, the method comprising:
codepositing a first component and a second component at a temperature below about 10° C. to form a product;
cooling the product to a temperature below about −5° C.; and
subjecting the product to a sublimation step for about 5 hours to about 20 hours and at a pressure of about 0.1 to about 1.0 mbar; and
wherein the first component is selected from the group consisting of a yogurt or other dairy product, a puree, a cereal product, a cheese, a fruit, a vegetable, a meat, a malt, a chocolate, coffee, fish or other seafood, and combinations thereof; and
wherein the second component may be selected from the group consisting of a yogurt or other dairy product, a puree, a cereal product, a cheese, a fruit, a vegetable, a meat, a malt, a chocolate, coffee, fish or other seafood, and combinations thereof.

14. The method of claim 13, wherein the codepositing occurs at a temperature from about −5° C. to about 10° C.

15. The method of claim 13, wherein the first and second components are viscous components having a viscosity between about 5 and about 600 Pas.

16. The method of claim 13, wherein the sublimation step comprises heating the product at a temperature between about 50° C. and 120° C.

17. The method of claim 13, wherein a final temperature of the product after sublimation is between about 20° C. and about 80° C.

18. The method of claim 13, further comprising codepositing first and second components onto a flat surface.

19. The method of claim 13, further comprising aerating the first component and/or the second component prior to the codepositing step.

20. The method of claim 13, further comprising prior to the codepositing step:
preparing a first viscous component;
preparing a second viscous component;
aerating at least one of the first component or the second component.
